(19) United States
(12) Patent Application Publication
(10) Pub. No.: US 2009/0304332 A1
(43) Pub. Date: Dec. 10, 2009

(54) Optical Splitter

(76) Inventor: Wolfgang Schweiker, Weyarn (DE)

Correspondence Address: CORNING INCORPORATED, INTELLECTUAL PROPERTY DEPARTMENT, SP-TI-3-1, CORNING, NY, 14831, US

(21) Appl. No.: 12/508,065

(22) Filed: Jul. 23, 2009

Related U.S. Application Data
(63) Continuation of application No. PCT/EP08/50965, filed on Jan. 28, 2008.

(30) Foreign Application Priority Data
Jan. 31, 2007 (DE) 102007004891.4

(51) Int. Cl. G02B 6/26

(52) U.S. Cl. 385/45; 385/39

(57) ABSTRACT

An optical splitter (100) has an optical conductor track arrangement (LB), which extends from a first side (S1) to a second side (S2) of an optical chip of the optical splitter. The conductor track arrangement (LB) has a plurality of branching nodes (K1) at which in each case a conductor track section (LB1) branches into a plurality of conductor track sections (LB2, LB3). At a branching node (K1), the light power fed in via a first conductor track section (LB1) is distributed non-uniformly between the conductor track sections (LB2, LB3), which are connected downstream and which branch from the branching node (K1). Receiving units (R1) that are at a greater distance from a transmitting unit (T) than other receiving units (R2) are connected to those conductor track sections (LB2) of the optical splitter which have a lower insertion loss on account of the non-uniform ratio of the splitting of the light power.

### RELATED APPLICATIONS

This application is a continuation of International Application No. PCT/EP08/050965, filed Jan. 28, 2008, which claims priority under 35 U.S.C. § 119(a) of German Application No. 102007004891.4, filed Jan. 31, 2007, the entire contents of the International Application being hereby incorporated by reference.

### TECHNICAL FIELD

The present disclosure relates to optical cables with features that provide easy access to and segregation between optical fibers in different groups of optical fibers.

The invention relates to an optical splitter in which light, proceeding from a transmitting station, is split between a plurality of lines that are in each case connected to a receiving station. The invention furthermore relates to a method for constructing an optical network using an optical splitter with which light fed from a transmitting station to the optical splitter is split between a plurality of lines that are in each case connected to a receiving station.

### BACKGROUND

In optical networks, optical splitters are used to receive on the input side light fed in from a transmitting station onto an optical line, for example a fiber-optic cable, and on the output side to distribute said light between different optical lines that are in each case connected to a receiving station. In the case of a passive optical network, the light is split between the output lines of the optical splitter within the optical splitter without the light being amplified.

FIG. 1 shows such a passive optical network (PON). In the case of such a network, light generated by a transmitting unit, for example a laser, in a transmitting station TS is forwarded via an optical line OL1 to a distribution station VS. In the distribution station, the light transmitted via the line OL1 is split between different optical lines OL2, . . . , OLn and fed via said lines to receiving units in respective receiving stations RS1, . . . , RSn. The splitting of the light arriving via the line OL1 between the lines OL2, . . . , OLn is effected in the distribution station VS by means of an optical splitter.

Optical splitters are used in different configurations depending on the number of incoming and outgoing lines. In the case of an optical splitter having the configuration 1×32, by way of example, light fed to the optical splitter via a single line is distributed between 32 lines on the output side.

In the case of a passive optical splitter, the light is split between the outgoing lines without the interposition of amplifier units. In the case of passive optical splitters having the configuration 1×32, distances between the transmitting station TS and the receiving stations RS1, . . . , RSn of approximately 10 km can be bridged. In the case of a cable connected to the optical splitter with losses of 0.4 dB/km, this transmission range corresponds to an insertion loss of the optical splitter of 17.1 dB.

If the distance between a transmitting station and a receiving station is more than 10 km, it is possible to use for example optical splitters having a configuration 1×16. In the case of optical splitters having the configuration 1×16, light fed to the optical splitters on the input side is distributed between 16 optical lines on the output side. Optical splitters having the configuration 1×16 have an insertion loss that is lower by approximately 3 dB. On account of the lower insertion loss of optical splitters having the configuration 1×16 by comparison with optical splitters having the configuration 1×32, light can be transmitted over greater distances between a transmitting station and the receiving stations by means of the optical splitters having the configuration 1×16. For assumed cable losses of 0.4 dB/km, optical splitters having the configuration 1×16 can be used for distances between a transmitting station and a receiving station of approximately 17.8 km, since optical splitters having the configuration 1×16 only have an insertion loss of 14 dB.

In the case of an optical network in which light is split by means of optical splitters having the configuration 1×16, only 16 receiving stations can be connected to each optical splitter. Therefore, for the same number of receiving stations when using optical splitters having a lower configuration, for example the configuration 1×16, in comparison with optical splitters having a higher configuration, for example the configuration 1×32, it is necessary to increase the number of optical splitters in an optical network. At the same time, it is also necessary to increase the number of transmitting units in the transmitting station if it is assumed that respectively one transmitting unit can be used for feeding one optical line. As a result, however, the production costs rise significantly in the case of a passive optical network having optical splitters having a lower configuration.

Therefore, there is a need to specify an optical splitter which is adapted to distances between transmitting and receiving stations of an optical network. Furthermore, it is desirable to specify a method for constructing an optical network using an optical splitter, wherein the optical splitter is adapted to distances between transmitting and receiving stations of an optical network.

### SUMMARY

One embodiment of an optical splitter comprises an optical conductor track arrangement for transmitting light, which arrangement runs from a first side of the optical splitter to a second side of the optical splitter. The optical conductor track arrangement comprises at least one branching node and a plurality of conductor track sections, wherein a first of the conductor track sections branches into a second and third of the conductor track sections at a first of the branching nodes. The light transmitted via the second of the conductor track sections and via the third of the conductor track sections during operation has different light power.

Consequently, the light power transmitted via the first of the conductor track sections is split at the branching node. The first of the conductor track sections is connected for example to an input of the optical splitter, at which light that has been generated for example by a transmitting unit in a transmitting station is coupled into the optical splitter. The second and third of the conductor track sections are connected to an output of the optical splitter. If, by way of example, as a result of the non-uniform splitting of the light at the branching node, light is transmitted with a higher light power via the second of the conductor track sections than via the third of the conductor track sections, for example receiving stations which are further away from the optical splitter or the transmitting station are connected to that output of the splitter which is connected to the second of the conductor track sections, since the light is transmitted with a lower attenuation via the second of the conductor track sections than via the third of the conductor track sections. Correspondingly, the receiving stations located nearer to the optical splitter or nearer to the transmitting station are connected to that output of the optical splitter which is connected to the third of the conductor track sections.

The first, second and third of the conductor track sections are embodied for example in such a way that light transmitted via the first of the plurality of conductor sections with a first light power is split into light with a second light power and light with a third light power at the first of the branching nodes wherein the second light power and the third light power are different from one another.

The first side of the optical splitter is connected to the first of the branching nodes for example via the first of the conductor track sections.

A second of the branching nodes can be provided, wherein the second of the conductor track sections branches into a fourth and fifth of the conductor track sections at the second of the branching nodes. Light transmitted via the second of the conductor track sections with the second light power is split into light with a fourth light power and a fifth light power at the second of the branching nodes, wherein the light with the fourth light power is transmitted via the fourth of the conductor track sections and the light with the fifth light power is transmitted via the fifth of the conductor track sections and the fourth light power and the fifth light power are different from one another.

In another embodiment of the optical splitter, the optical splitter can have a second of the branching nodes, wherein the second of the conductor track sections branches into a fourth and fifth of the conductor track sections at the second of the branching nodes. Light transmitted via the second of the plurality of conductor sections with a second light power is split at the second of the branching nodes into light that is transmitted respectively via the fourth and fifth of the conductor track sections with the same light power.

The second side of the optical splitter can be connected to the first of the branching nodes in each case via the second and third of the conductor track sections.

In another embodiment of the optical splitter, the second side of the optical splitter can be connected to the second of the branching nodes in each case via the fourth and fifth of the conductor track sections.

A width of the second of the conductor track sections can be different from a width of the third of the conductor track sections.

The second and the third of the conductor track sections can branch at different angles with respect to the first of the conductor track sections at the first of the branching nodes.

By changing the width of the conductor track sections that branch from a branching node, it is possible to obtain a non-uniform splitting of the light power. Furthermore, a non-uniform splitting of the light power is also achieved by altering a first angle between an edge of the second of the conductor track sections and an edge of the first of the conductor track sections and by altering a second angle between an edge of the third of the conductor track sections and an edge of the first of the conductor track sections. A non-uniform splitting of the light power is generally effected when the first and second angles are different from one another.

The optical splitter can comprise a carrier substrate, on which the optical conductor track arrangement is arranged, wherein the carrier substrate contains silicon or silicon dioxide.

The optical splitter can be embodied for example in a configuration 1×8, 1×16, 1×64, 2×8, 2×16, 2×32 or 2×64.

A method for constructing an optical network using an optical splitter according to any of the embodiments mentioned above is specified below. In accordance with the method, a transmitting unit is connected to an input of the optical splitter. A first receiving unit is connected to a first output of the optical splitter. A second receiving unit is connected to a second output of the optical splitter, wherein the first and second receiving units are at different distances from the optical splitter. Light is fed in at the input of the optical splitter onto the first of the conductor track sections of the conductor track arrangement of the optical splitter. The light is split at a branching node between the second and third of the conductor track sections of the conductor track arrangement of the optical splitter, wherein the light is transmitted via the second and third of the conductor track sections with different light power. The light transmitted via the second of the conductor track sections is provided at the first output. The light transmitted via the third of the conductor track sections is provided at the second output of the optical splitter.

That one of the first and second receiving units which is at a further distance from the optical splitter can be connected to that one of the second and third of the conductor track sections on which the light with the higher of the second light power and third light power is transmitted.

A ratio of the light power with which the light having the first light power is split between the second and third of the conductor track sections can be set in a manner dependent on the distance of the first and second receiving units from the optical splitter.

The ratio of the light power with which the light having the first light power is split between the second and third of the conductor track sections can be set by changing a respective width of the second and third of the conductor track sections.

The ratio of the light power with which the light having the first light power is split between the second and third of the conductor track sections can also be set by changing a respective angle at which the second and third of the conductor track sections branch with respect to the first of the conductor track sections at the first of the branching nodes.

### BRIEF DESCRIPTION OF THE FIGURES

The invention is explained in more detail below with reference to figures showing exemplary embodiments of the present invention. In the figures:

FIG. 1 shows an embodiment of a passive optical network,

FIG. 2 shows a longitudinal section through an embodiment of an optical splitter,

FIG. 3 shows a plan view of an embodiment of an optical splitter,

FIG. 4 shows a cross section through an embodiment of an optical chip of an optical splitter,

FIG. 5 shows an embodiment of an optical splitter with a conductor track arrangement that branches into conductor track sections at branching nodes,

FIG. 6 shows an embodiment of conductor track sections of an optical conductor track arrangement at a branching node of an optical splitter,

FIG. 7 shows an embodiment of a passive optical network.

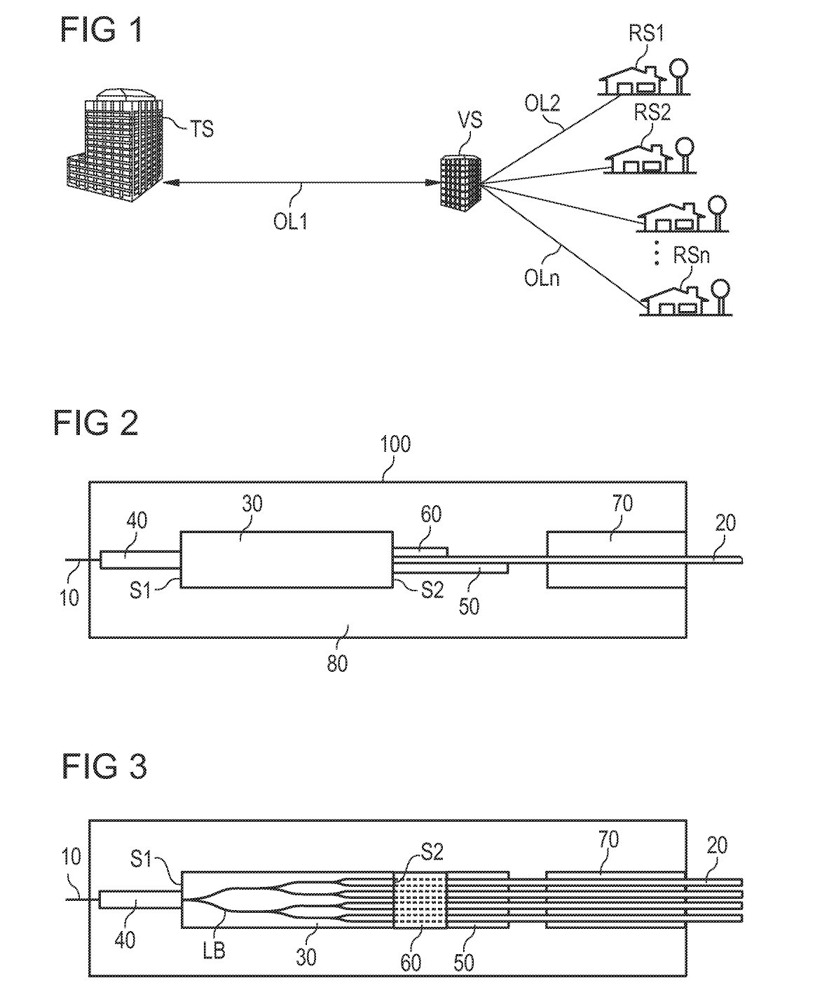

### DETAILED DESCRIPTION

FIG. 2 shows a longitudinal section of an optical splitter 100. An optical chip 30 having a side S1 and a side S2 is arranged in a housing 80. In the optical chip 30, a conductor track arrangement comprising a multiplicity of conductor track sections runs from the side S1 to the side S2. In this case, a conductor track section connected to the side S1 branches at a plurality of branching nodes into a multiplicity of conductor track sections that run to the side S2 of the optical chip. An optical waveguide 10 is connected to the input side S1, said optical waveguide being surrounded by a reinforcing structure 40. In one possible embodiment, the reinforcing structure can be embodied as a conductor end sleeve (ferrule). The conductor end sleeve used can be a small glass tube, for example, into which the optical waveguide 10 is embedded. The reinforcing structure serves as a holding unit in order to adhesively bond the optical waveguide 10 for example by means of an adhesive at the side S1 of the optical chip 30.

Light coupled in via the optical waveguide 10 onto an individual conductor track section of the conductor track arrangement at the side S1 of the optical chip is distributed between a plurality of optical waveguides 20 after being split up by the conductor track network of the optical chip 30 at the side S2. For fixing the plurality of optical waveguides 20, a carrier substrate 50 and a V-groove lamina 60 are fixed to the side S2 of the optical chip. The optical waveguides 20 run in the grooves of the V-groove lamina and are thus aligned with the conductor track sections of the conductor track arrangement running within the optical chip 30. Furthermore, a strain relief element 70 is arranged at the housing 80, and protects the individual optical waveguides 20 from being torn away from the carrier substrate 50 or the side S2 of the optical chip on account of tensile loading.

FIG. 3 shows a plan view of an embodiment of the optical splitter from FIG. 2. The optical chip 30 has an optical conductor track arrangement LB, which is connected by an individual one of its conductor track sections to the side S1 of the optical chip. The optical waveguide 10 is fixed to the side S1 of the optical chip by means of the conductor end sleeve 40. The optical conductor track arrangement LB branches at a plurality of branching nodes into a multiplicity of conductor track sections that run to the side S2 of the optical chip. At the side S2 of the optical chip, the optical waveguides 20 are arranged on the carrier substrate 50, which is fixed to the side S2 of the optical chip by means of an adhesive, for example. The V-groove lamina is arranged above the carrier substrate 50, the alignment of the optical waveguides 20 with the conductor track sections of the optical conductor track arrangement LB that run to the side S2 being effected by means of said V-groove lamina.

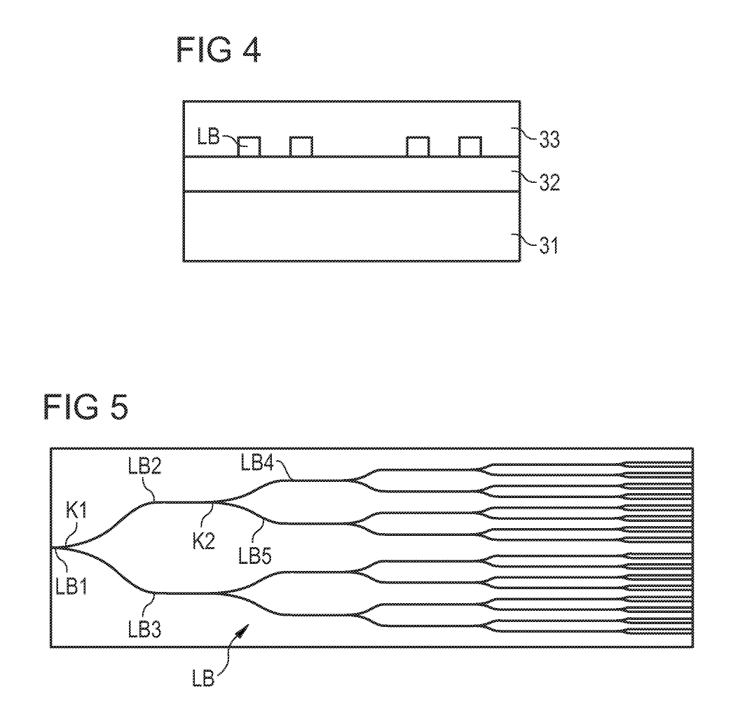

FIG. 4 shows a cross section through an embodiment of the optical chip 30 of the optical splitter. A buffer layer 32 is arranged on a substrate 31, which contains silicon or silicon dioxide, for example, said buffer layer containing silicon dioxide, for example. The conductor track sections of the optical conductor track arrangement LB are arranged on the buffer layer 32, said conductor track sections being surrounded by a protective layer 33.

FIG. 5 shows the optical conductor track arrangement LB of the optical chip 30 of the optical splitter in an enlarged illustration. The optical conductor track arrangement LB runs from a side S1 to a side S2 of the optical chip, wherein it branches from an individual conductor track section into a multiplicity of conductor track sections that run to the side S2 of the optical chip. An optical splitter in the configuration 1×32 is illustrated in the exemplary embodiment in FIG. 5. A conductor track section LB1 branches at a branching node K1 into a conductor track section LB2 and a conductor track section LB3. In this case, the conductor track sections LB1, LB2 and LB3 at the branching node K1 are embodied in such a way that a light power of the light coupled into the conductor track section LB1 from a transmitting unit is distributed non-uniformly between the conductor track sections LB2 and LB3. By way of example, the conductor track sections LB2 and LB3 at the branching node K1 are arranged in such a way that 30% of the light conduction coupled in onto the conductor track section LB1 is forwarded onto the conductor track section LB3. The remaining 70% of the light power coupled in onto the conductor track section LB1 is forwarded on the conductor track section LB2.

Since a higher light power is passed on the conductor track section LB2, light that is forwarded via the conductor track section LB2 and the downstream conductor track sections to the side S2 of the optical chip can be transmitted to receiving stations that are further away from the optical splitter than those receiving stations which are connected to the conductor track sections that are fed by the conductor track section LB3, since only 30% of the light power is transmitted via the conductor track section LB3.

In the example given of a non-uniformly constructed optical splitter in which the light power is split non-uniformly at the first branching node K1, wherein 70% of the light power coupled in is transmitted on the conductor track section LB2 and 30% of the light power coupled in is transmitted on the conductor track section LB3, a possible transmission range between a transmitting station and a receiving station connected to the conductor track sections connected to the conductor track section LB2 of 13.8 km results if a cable attenuation of 0.4 dB/km is assumed. This corresponds to an insertion loss of the optical splitter of 15.6 dB in the transmission of light via the conductor track section LB2.

Conversely, the transmission range decreases for signals that are transmitted via the conductor track section LB3 to the side S2 of the optical splitter. If, on account of the division ratio of 70/30, only 30% of the light power coupled in onto the conductor track section LB1 is transmitted via the conductor track section LB3 to the side S2, the possible range between a transmitting station and a receiving station connected to conductor track sections connected to the conductor track section LB3 is 4.5 km given an assumed cable attenuation of 0.4 dB/km. This corresponds to an insertion loss of 19.3 dB of the optical splitter in the transmission of light via the conductor track section LB3.

However, since generally a number of receiving stations connected to the optical splitter are at a shorter distance from the transmitting station than other receiving stations, in particular those receiving stations which are at the shorter distance can be connected to the conductor track sections of the optical splitter which have a higher attenuation. The more distant receiving stations, by contrast, are connected to those conductor track sections on which a higher power is transmitted on account of the non-uniform power division ratio.

This makes it possible to use in an optical network an optical splitter in which an individual conductor track section is branched between a large number of conductor track sections in order to bridge different distances between the transmitting station and the receiving stations. The use of uniformly constructed optical splitters in which light is split uniformly between the connected conductor track sections at each branching node and which have fewer conductor track sections at the side S2 can thus be avoided. By way of example it is no longer necessary, for the transmission of light over distances greater than 10 km, to replace one optical splitter having the configuration 1×32 by two optical splitters having the configuration 1×16.

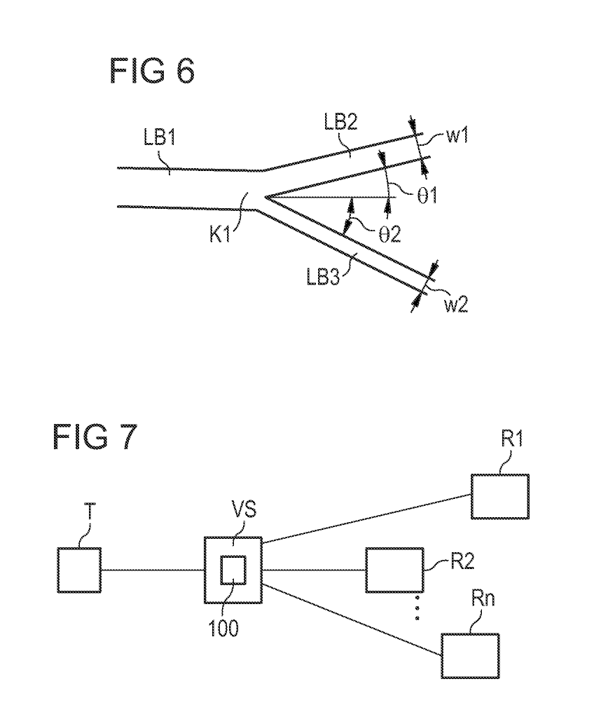

FIG. 6 shows an embodiment of an optical splitter which makes it possible for light power of light fed in onto the conductor track section LB1 to be split between the conductor track sections LB2 and LB3 with a non-uniform power division ratio at the branching node K1. For this purpose, in one possible embodiment, the conductor track sections LB2 and LB3 are embodied with different widths. The conductor track section LB2 having the larger width has a lower insertion loss, whereas the conductor track section LB3 having the smaller width has a higher insertion loss.

A further possibility for altering the power division ratio consists in altering non-uniformly or asymmetrically angles φ1 and φ2 at which the conductor track sections LB2 and LB3 branch with respect to the coupling-in conductor track section LB1 at the branching node K1. The angles φ1 and φ2 in each case form angles lying between a longitudinal axis of the conductor track sections LB1 and LB2, and respectively LB1 and LB3. By way of example, the angle φ1 can be made greater than the angle φ2, with the result that the conductor track section LB2 branches at a steeper angle than the conductor track section LB3.

FIG. 7 shows a passive optical network in which light is transmitted from a transmitting unit T of a transmitting station via an optical line OL1 to a distribution station VS having an optical splitter 100. Receiving units R1, . . . , Rn are connected to the optical splitter 100 on the output side, said receiving units being at different distances from the transmitting unit. Those receiving units which are at a greater distance from the transmitting unit are connected to those conductor track sections which have a lower insertion loss. Those conductor track sections which have a higher insertion loss on account of the non-uniform power division ratio at a branching node are connected to those receiving units which are nearer to the transmitting unit.

In one possible embodiment of the optical splitter, the power division ratio is altered only at the branching node K1, whereas at the branching nodes disposed downstream the light power is distributed uniformly between the conductor track sections connected downstream. In another embodiment of the optical splitter, the power division ratio is additionally altered at the nodes connected downstream of the node K1. By way of example, a non-uniform splitting of the power is effected at the branching node K1 and a further non-uniform splitting of the power is additionally effected at the node K2. It is likewise possible in the embodiment provided in FIG. 5, for example, to configure the optical conductor track arrangement LB in such a way that a uniform splitting of the power between the conductor track sections LB2 and LB3 is effected at the node K1 and a non-uniform power splitting between downstream conductor track sections LB4 and LB5 is effected at the branching node K2.

This makes it possible to adapt an optical splitter to a specific application or to different distances between different receiving stations and a transmitting station. An optical splitter having non-uniform power division ratios at the branching nodes or an optical splitter having a combination of uniform and non-uniform power splitting at the branching nodes makes it possible to continuously use in an optical network an optical splitter having a high number of output channels, for example an optical splitter having the configuration 1×32, instead of changing over to two optical splitters having the configuration 1×16.

It is also possible to construct optical splitters having other configurations, for example optical splitters having configurations 1×8 (one input to 8 outputs), 1×16 (one input to 16 outputs), 1×64 (one input to 64 outputs), 2×8 (two inputs to 8 outputs), 2×16 (two inputs to 16 outputs), 2×32 (two inputs to 32 outputs) or 2×64 (two inputs to 64 outputs), with a non-uniform splitting of light power.

The optical splitter can be used in an optical network for distributing light from a transmitting unit to a receiving unit. In this case, those receiving units which are further away from the splitter or from the transmitting unit are connected to those conductor track sections of the conductor track arrangement of the splitter on which the light with the higher power is guided or which have a lower insertion loss. Those receiving units which lie nearer to the transmitting unit or the optical splitter are connected to those conductor track sections of the conductor track arrangement on which the light with the lower power is transmitted or which have the higher insertion loss.

What is claimed:

1. An optical splitter, comprising:
an optical conductor track arrangement for transmitting light, wherein the track arrangement runs from a first side of the optical splitter to a second side of the optical splitter, wherein
the optical conductor track arrangement comprises at least one branching node and a plurality of conductor track sections, wherein a first of the conductor track sections branches into a second and third of the conductor track sections at a first of the branching nodes, and wherein
the light transmitted via the second of the conductor track sections and via the third of the conductor track sections during operation has different light power.

2. The optical splitter of claim 1, wherein light transmitted via the first of the plurality of conductor track sections with a first light power is split into light with a second light power and light with a third light power at the first of the branching nodes wherein the second light power and the third light power are different from one another.

3. The optical splitter of claim 2, wherein the first side of the optical splitter is connected to the first of the branching nodes via the first of the conductor track sections.

4. The optical splitter of claim 3, further comprising a second of the branching nodes, wherein the second of the conductor track sections branches into a fourth and fifth of the conductor track sections at the second of the branching nodes, and wherein light transmitted via the second of the conductor track sections with the second light power is split into light with a fourth light power and a fifth light power at the second of the branching nodes, wherein the light with the fourth light power is transmitted via the fourth of the conductor track sections and the light with the fifth light power is transmitted via the fifth of the conductor track sections and the fourth light power and the fifth light power are different from one another.

5. The optical splitter of claim 1, wherein the first side of the optical splitter is connected to the first of the branching nodes via the first of the conductor track sections.

6. The optical splitter of claim 1, comprising a second of the branching nodes, wherein the second of the conductor track sections branches into a fourth and fifth of the conductor track sections at the second of the branching nodes, and wherein light transmitted via the second of the plurality of conductor track sections with a second light power is split at the second of the branching nodes into light that is transmitted respectively via the fourth and fifth of the conductor track sections with the same light power.

7. The optical splitter of claim 1, wherein the second side of the optical splitter is connected to the first of the branching nodes in each case via the second and third of the conductor track sections.

8. The optical splitter of claim 1, wherein the second side of the optical splitter is connected to the second of the branching nodes in each case via the fourth and fifth of the conductor track sections.

9. The optical splitter of claim 1, wherein a width of the second of the conductor track sections is different from a width of the third of the conductor track sections.

10. The optical splitter of claim 1, wherein the second and the third of the conductor track sections branch at different angles with respect to the first of the conductor track sections at the first of the branching nodes.

11. The optical splitter of claim 1, comprising a carrier substrate, on which the optical conductor track arrangement is arranged, wherein the carrier substrate contains silicon or silicon dioxide.

12. The optical splitter of claim 1, wherein the splitter has a 1×8, 1×16, 1×64, 2×8, 2×16, 2×32 or 2×64 configuration.

13. A method for constructing an optical network using an optical splitter comprising an optical conductor track arrangement for transmitting light, wherein the track arrangement runs from a first side of the optical splitter to a second side of the optical splitter, wherein the optical conductor track arrangement comprises at least one branching node and a plurality of conductor track sections, wherein a first of the conductor track sections branches into a second and third of the conductor track sections at a first of the branching nodes, and wherein the light transmitted via the second of the conductor track sections and via the third of the conductor track sections during operation has different light power, the method comprising:
connecting a transmitting unit to an input of the optical splitter;
connecting a first receiving unit to a first output of the optical splitter;
connecting a second receiving unit to a second output of the optical splitter, wherein the first and second receiving units are at different distances from the optical splitter;
feeding in light at the input of the optical splitter onto the first of the plurality of conductor track sections of the conductor track arrangement;
splitting the light at one of the branching nodes between the second and third of the conductor track sections of the conductor track arrangement, wherein the light is transmitted via the second and third of the conductor track sections with different light power; and
providing the light transmitted via the second of the conductor track sections at the first output and the light transmitted via the third of the conductor track sections at the second output of the optical splitter.

14. The method of claim 13, wherein that one of the first and second receiving units which is at a further distance from the optical splitter is connected to that one of the second and third of the conductor track sections on which the light with the higher of the second light power and third light power is transmitted.

15. The method of claim 14, wherein a ratio of the light power with which the light having the first light power is split between the second and third of the conductor track sections is set in a manner dependent on the distance of the first and second receiving units from the optical splitter.

16. The method of claim 13, wherein a ratio of the light power with which the light having the first light power is split between the second and third of the conductor track sections is set in a manner dependent on the distance of the first and second receiving units from the optical splitter.

17. The method of claim 13, wherein the ratio of the light power with which the light having the first light power is split between the second and third of the conductor track sections is set by changing a respective width of the second and third of the conductor track sections.

18. The method of claim 13, wherein the ratio of the light power with which the light having the first light power is split between the second and third of the conductor track sections is set by changing a respective angle at which the second and third of the conductor track sections branch with respect to the first of the conductor track sections at the first of the branching nodes.

19. The method of claim 13, wherein a carrier substrate on which the optical conductor track arrangement is arranged contains silicon or silicon dioxide.
